(19) United States
(12) Patent Application Publication
(10) Pub. No.: US 2006/0185227 A1
(43) Pub. Date: Aug. 24, 2006

(54) Net-plate set for horticulture or ornament

(76) Inventor: Chih-Ping Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/108,678

(22) Filed: Apr. 19, 2005

(30) Foreign Application Priority Data
Feb. 18, 2005 (TW) 094104766

(51) Int. Cl. A01G 9/08

(52) U.S. Cl. 47/1.01 R

(57) ABSTRACT

A net-plate set for horticulture or ornament includes multiple net-plates. Each net-plate includes a net-body and a frame. The frame is fixed around the edge of the net-body. In order to assemble net-plates into a three-dimensional object, each net-plate is flexible and bendable and the net-plates are linked together by one or more linking members. Before the net-plates are assembled into a three-dimensional object, each net-plate can be flat to reduce volume for much easier shipment.

### BACKGROUND OF THE INVENTION

1. Field of the Invention

The present invention relates to a tool suitable for horticultural or ornamental sculpturing. This tool can be used for tree trimming, bird cages, lanterns, or snow/sand/net sculptures.

2. Description of the Related Art

A very popular hobby is the trimming of plants (which typically are leaved plants, such as Chinese banyan (Ficus microcarpa), Orange jessamine (Murraya paniculata), Amur maple (Acer ginnala), Japanese pepper (Zanthoxylum piperitum), and English ivy, into decorative shapes, such as animal or cartoon character shapes.

There are two traditional methods to perform such trimming. The first is to totally rely on a gardener's technique and skill. The second is to use a steel bar or a steel rod that is welded together to form a suitable shape, and the plant is then trimmed to the shape.

Both of the two traditional methods are very difficult to implement, and their results are not consistent. Due to their large sizes, it is very difficult to transport the metal forms. Moreover, maintaining the shapes of the growing plants is difficult.

Therefore, it is desirable to provide a net-plate set for horticulture or ornament to mitigate and/or obviate the aforementioned problems.

### SUMMARY OF THE INVENTION

A main objective of the present invention is to provide a tool suitable for (horticultural or ornamental sculpturing. This tool can be used for tree trimming, bird cages, lanterns, or snow/sand/net sculptures.

Another objective of the present invention is to provide a plurality of net-plates which are easy for transportation and storage. A user can refer to an assembly instruction to assemble the plurality of net-plates into a three-dimensional shape.

In order to achieve the above-mentioned objectives, the net-plate set for horticulture or ornament comprises a plurality of net-plates, each net-plate is flexible and comprises: a net-body with edges; and a frame fixed around the edges of the net-body; wherein the plurality of net-plates can be assembled into a three-dimensional object.

Before the net-plates are assembled into a three-dimensional object, each net-plate can be flat to reduce volume. When the net-plates are assembled into a three-dimensional object, each net-plate prefers not to be overlapped, and the frame of each net-plate is connected to at least another frame of the net-plate.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an assembled embodiment according to the present invention.

FIG. 2 to FIG. 27 are plane drawings of different net-plates in the embodiment according to the present invention

FIG. 28 is a perspective view of an assembled net-plate shown in FIG. 19 according to the present invention.

FIG. 29 is a detailed view of the net-plate shown in FIG. 19.

FIG. 30 is a schematic drawing for tree trimming.

### DETAILED DESCRIPTION OF THE PREFERRED EMBODIMENT

Although the net-plate set of the present invention is suitable for both horticultural and ornamental sculptures, the following embodiments illustrate the present invention as applied to horticulture.

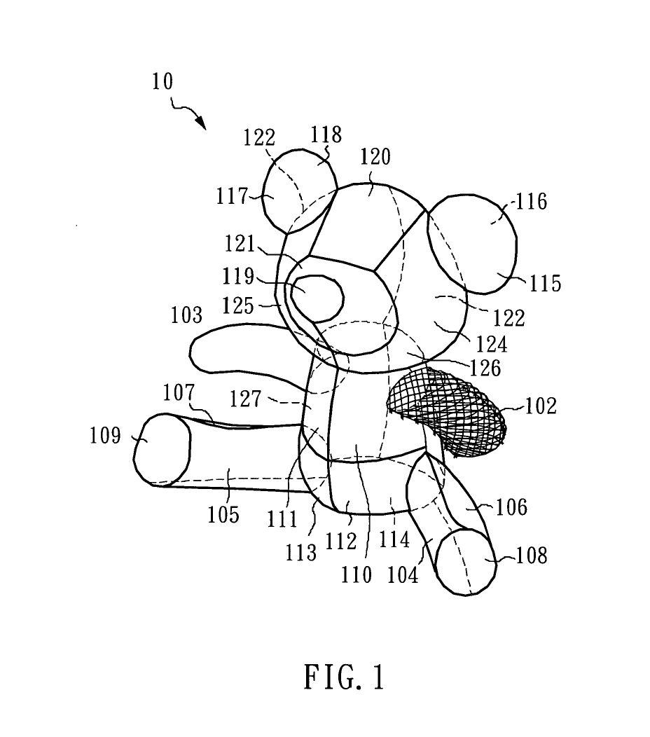

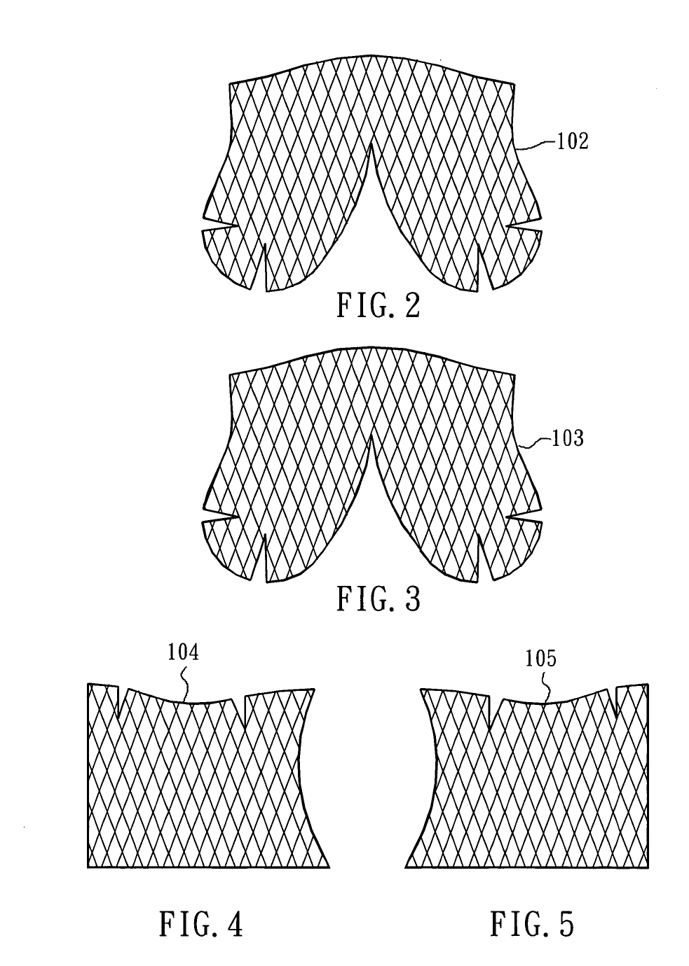

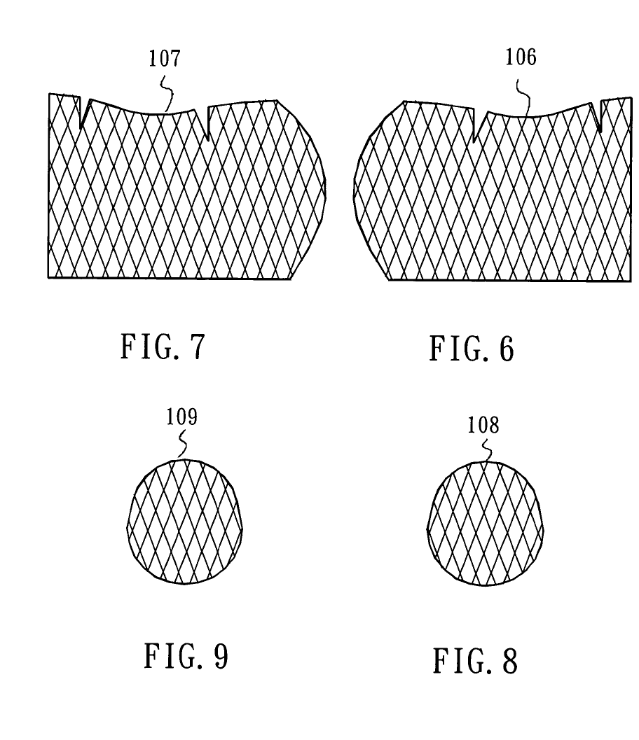

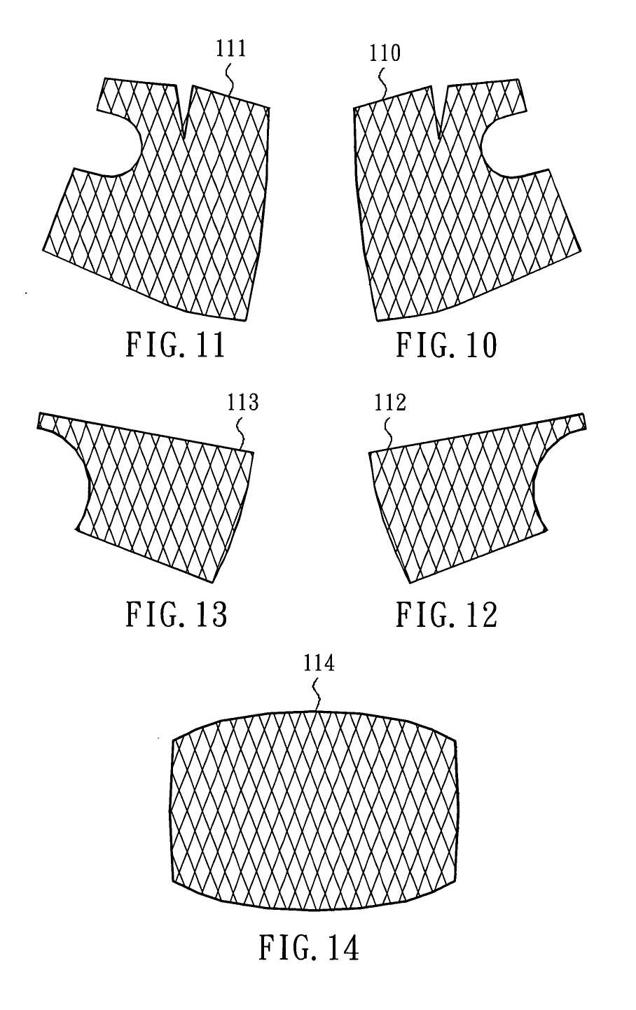

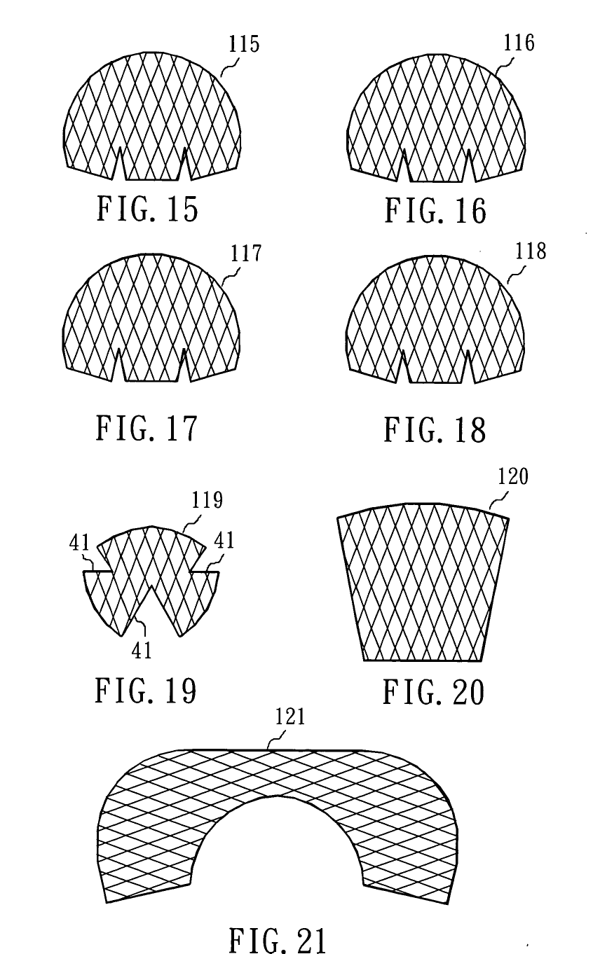

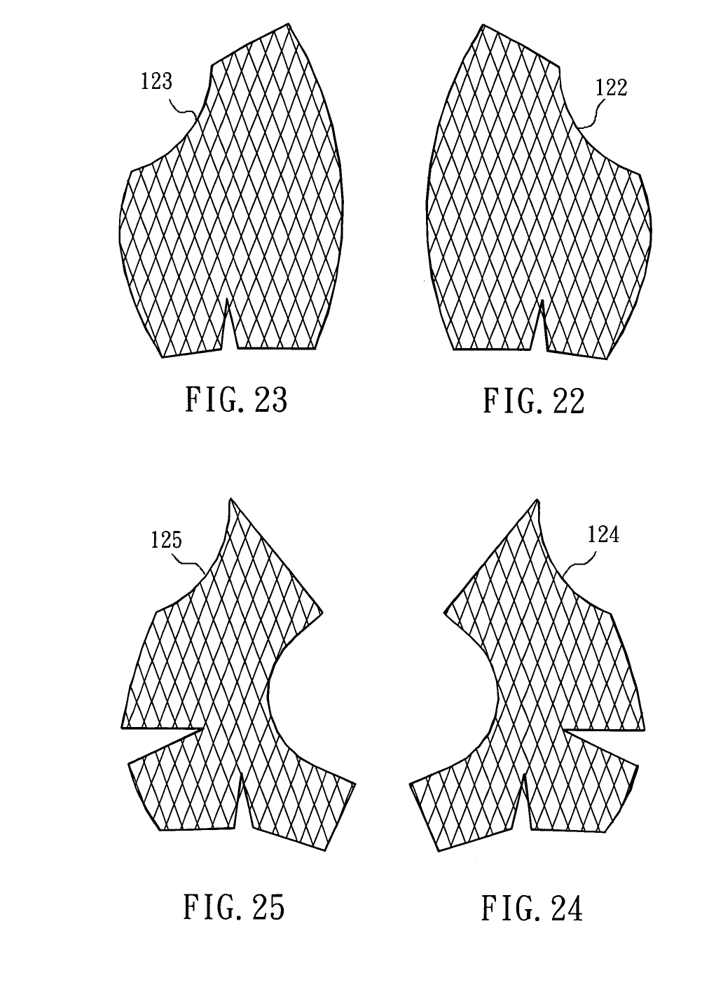

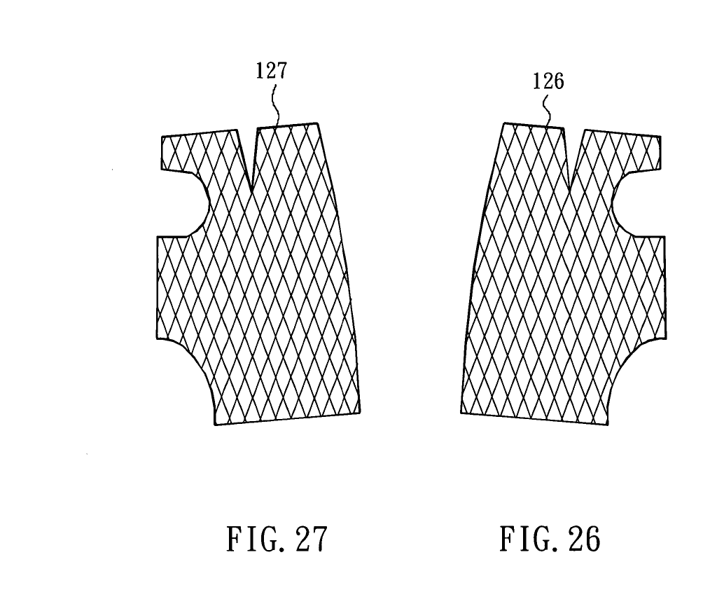

Please refer to FIG. 1. FIG. 1 is a perspective view of an assembled net-plate set 10 in a “teddy bear” shape. In this embodiment, the net-plate set 10 for horticulture comprises 26 net-plates 102-127, and each net-plate is separately shown in FIG. 2˜FIG. 27. Furthermore, each net-plate further comprises a net-body 30, but only the net-body of net-plate 102 is shown in FIG. 1 for clarity.

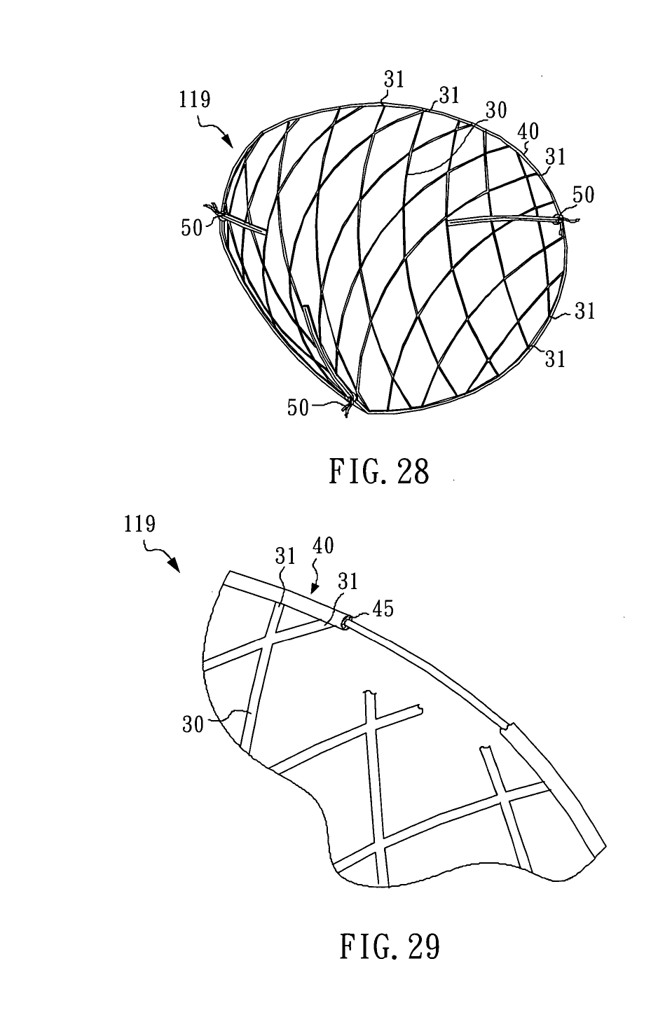

All net-plates have identical structure, but have different shapes and sizes. Using the net-plate 119 as an example, please refer to FIG. 19, FIG. 28, and FIG. 29. The net-plate 119 comprises a net-body 30 and a frame 40. The frame 40 is fixed on edges 31 of the net-body 30. In order to assemble the plurality of net-plates 102-127 into a three-dimensional object, each net-plate is flexible, and preferably made from steel or copper, or flexible plastic. The net-body 30 can be made of typical steel net, and may be welded or connected to the steel frame 40 at its edges 31 to cut the correct shape. If the net-plate 119 is made of steel, to prevent rusting and to maintain a presentable appearance, the net-plate 119 can be dipped in a plastic liquid to form a plastic layer 45 that coats the net-body 30 and the frame 40 (much like the typical coat or clothes hanger), as shown in FIG. 29. Before the net-plate set 10 is assembled, every net-plate 102-127 can be flat to reduce its volume. When assembling the plurality of net-plates 102-127, a user can refer to an assembly instruction (not shown) or an instruction drawing (not shown). In order to reduce materials and to simplify the assembly process, the net-body 30 of each net-plate 102-127 prefers not to overlap, but the frame 40 of each net-plate 102-127 is connected to at least one frame 40 of another net-plate. As shown in FIG. 1, the frame of the net-plate 120 and the frame of the net-plate 124 are connected.

As shown in FIG. 19, the frame 40 of the net-plate 119 has three V-shaped edges 41; by connecting the V-shaped edges 41 together, the net-plate 119 can be assembled into a desired shape, as shown in FIG. 28. The V-shaped edges 41 can be connected by different connection members 50 such as string, tape, hooks, buckles, clips, fasteners, or ties that connect adjacent frames 40 together. In this embodiment, the connection members 50 are thin wires, and all connection members 50 can be pre-attached to the frames 40 to simplify use for the user, although this is not necessary. The other net-plates 102-127 (except the net-plate 119) all have the same structure as the net-plate 119, so each net-plate 102-127 has a net-body and a frame, but not every frame has a V-shaped edge, for example, the frame of the net-plate 108 has no V-shaped edge.

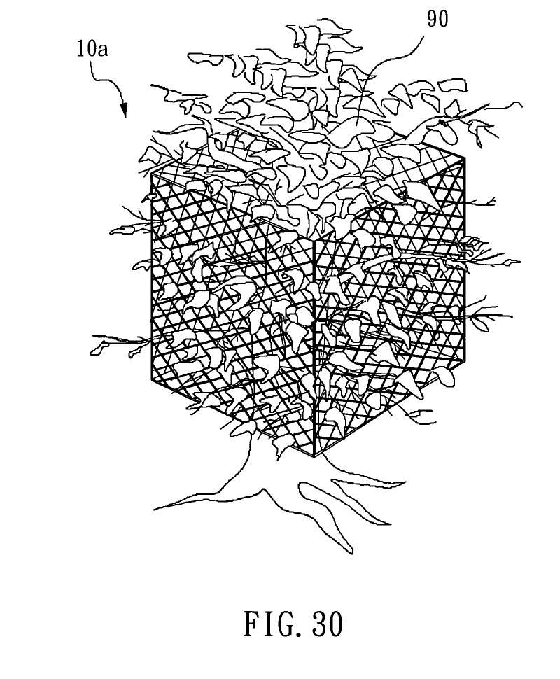

Please refer to FIG. 30. FIG. 30 is a schematic drawing for tree trimming. As shown in the drawing, the user can utilize an assembled square net-plate set 10a, place it on a tree 90, and then trim away the surplus branches.

The depicted embodiment is assembled in a “teddy bear shape”. In addition, please note that other different shapes, such as a “dog shape”, can also be applied by the present invention. Furthermore, different structural designs of the net-plates can be made to create the same shape. The design of the net-plate depends upon the final shape, the maximum size and minimum size of the net-body, and transportation convenience.

Although the present invention has been explained in relation to its preferred embodiment, it is to be understood that all other possible modifications and variations can be made without departing from the spirit and scope of the invention as hereinafter claimed.

What is claimed is:

1. A net-plate set for horticulture or ornament comprising a plurality of net-plates, each net-plate being flexible and each net-plate comprising:
a net-body with edges; and
a frame fixed around the edges of the net-body;
wherein the plurality of net-plates can be assembled into a three-dimensional object.

2. The net-plate set for horticulture or ornament as claimed in claim 1, wherein the net-plate is flat before being assembled.

3. The net-plate set for horticulture or ornament as claimed in claim 1, the frame of every net-plate is connected to at least another frame of the net-plate when the plurality of net-plates are assembled into a three-dimensional object.

4. The net-plate set for horticulture or ornament as claimed in claim 3 further comprising a plurality of flexible connection members, the plurality of flexible connection members used for connecting the frames of adjacent frames of the net-plates.

5. The net-plate set for horticulture or ornament as claimed in claim 1, wherein each net-body is made of metal.

6. The net-plate set for horticulture or ornament as claimed in claim 1, wherein each frame is made of metal.

7. The net-plate set for horticulture or ornament as claimed in claim 1, wherein at least one frame of the net-plate includes at least one V-shaped edge.
